(19) United States
(12) Patent Application Publication
(10) Pub. No.: US 2025/0347804 A1
(43) Pub. Date: Nov. 13, 2025

(54) MILLIMETER-WAVE-BASED THREE-DIMENSIONAL ANTHROPOMETRIC MEASUREMENT SYSTEM AND MEASUREMENT METHOD

(71) Applicant: Anhui Yuanshuo Terahertz Technology Co., LTD, Hefei (CN)

(72) Inventor: Zhenli ZHAO, Hefei (CN)

(73) Assignee: Anhui Yuanshuo Terahertz Technology Co., LTD, Hefei (CN)

(21) Appl. No.: 19/095,131

(22) Filed: Mar. 31, 2025

Related U.S. Application Data
(63) Continuation of application No. PCT/CN2024/126631, filed on Oct. 23, 2024.

(30) Foreign Application Priority Data
May 10, 2024 (CN) 202410577907.8

(51) Int. Cl. G01S 13/89; G01S 7/282; G01S 7/295; G01S 7/35

(52) U.S. Cl. CPC G01S 13/89; G01S 7/282; G01S 7/295; G01S 7/352

(57) ABSTRACT

The present disclosure relates to anthropometric measurement, and more particularly relates to a millimeter-wave-based three-dimensional anthropometric measurement system and measurement method. The millimeter-wave-based three-dimensional anthropometric measurement system includes: a millimeter-wave component configured for generating a millimeter-wave signal and sending the millimeter-wave signal to an antenna array component, and receiving an echo signal of a target to be measured sent by the antenna array component; the antenna array component configured for sending the millimeter-wave signal to the target to be measured, and receiving the echo signal of the target to be measured and sending the echo signal to the millimeter-wave component; a signal collecting and processing component configured for controlling a transmitting channel and a receiving channel of the millimeter-wave component to switch, and collecting and processing the echo signal received by the millimeter-wave component.

### CROSS-REFERENCE TO RELATED APPLICATIONS

The application claims priority to Chinese patent application No. 202410577907.8, filed on May 10, 2024, the entire contents of which are incorporated herein by reference.

### TECHNICAL FIELD

The present disclosure relates to anthropometric measurement, and more particularly relates to a millimeter-wave-based three-dimensional anthropometric measurement system and measurement method.

### BACKGROUND

A traditional measurement mode of human body dimension data is manual contact measurement, and a measurer utilizes related equipment to measure dimension information of various human body parts of a person to be measured. This measurement mode is relatively convenient and quick, and thus has been used in traditional manual workshops and advanced clothing customization for a long time. However, due to the lack of professional measurement knowledge, the data obtained by the manual contact measurement is not accurate enough, and a measurement process takes a relatively long time, which often causes fatigue or distress to the person to be measured. Therefore, the application of non-contact measurement by utilizing devices is more and more widespread. The non-contact measurement mainly includes two-dimensional human body measurement and three-dimensional human body measurement.

For the two-dimensional human body measurement, firstly two-dimensional images of a front surface, a rear surface and a side surface of the person to be measured are shot, then the images are pre-processed to further obtain a clear human body contour, and then the dimension information of the various human body parts is calculated or simulated by using a mathematical model. Contours of the front and side surfaces are extracted from the images of the front and side surfaces of the person to be measured, the girth of feature parts is obtained, and finally a circumference prediction model is established. A two-dimensional human body measurement technology has relatively high requirements for the model, relatively large errors and relatively low measurement efficiency.

The measurement mode in which a human body photograph is shot by utilizing a photographic imaging principle is called a passive three-dimensional human body measurement technology. Based on a two-dimensional photograph, a human body three-dimensional model is acquired by a three-dimensional reconstruction technology, and color texture can be obtained directly, thereby effectively making up for the deficiency of active methods such as a three-dimensional laser scanner. Although the passive three-dimensional human body measurement technology is relatively low in cost and simple and convenient to measure, a camera used by this technology has relatively high requirements for shooting conditions, and sensitive parts of a human body cannot be fully recovered, thereby having relatively large errors.

At present, an active three-dimensional human body measurement technology which can penetrate clothes is basically X-ray scanning and millimeter-wave scanning. The millimeter-wave scanning is harmless to the human body relative to X-ray radiation injury, and may scan a whole body of the person to be measured without taking off clothes, so as to obtain the human body three-dimensional model, thereby better protecting individual privacy of the person to be measured.

### SUMMARY

### (I) Technical Problem to be Solved

In view of the above shortcomings existing in the prior art, the present disclosure provides a millimeter-wave-based three-dimensional anthropometric measurement system and measurement method which can effectively overcome the defects of relatively low anthropometric measurement accuracy and efficiency, and incapability of better protecting individual privacy of a target to be measured existing in the prior art.

### (II) Technical Solution

In order to achieve the above object, the present disclosure is implemented by the following technical solution:
a millimeter-wave-based three-dimensional anthropometric measurement system includes a millimeter-wave component, an antenna array component, a signal collecting and processing component, an imaging algorithm and data processing component and a terminal device;
wherein the millimeter-wave component is configured for generating a millimeter-wave signal and sending the millimeter-wave signal to the antenna array component, and receiving an echo signal of a target to be measured sent by the antenna array component;
the antenna array component is configured for sending the millimeter-wave signal to the target to be measured, and receiving the echo signal of the target to be measured and sending the echo signal to the millimeter-wave component;
the signal collecting and processing component is configured for controlling a transmitting channel and a receiving channel of the millimeter-wave component to switch, and collecting and processing the echo signal received by the millimeter-wave component;
the imaging algorithm and data processing component is configured for performing an imaging algorithm operation on the echo signal processed by the signal collecting and processing component, so as to achieve three-dimensional imaging of the target to be measured, and convert a three-dimensional image into a three-dimensional human body shape and three-dimensional human body data; and
the terminal device includes control keys required by the system for displaying the three-dimensional image, the three-dimensional human body shape and the three-dimensional human body data of the target to be measured, and has a voice broadcasting function.

Preferably, the system further includes a transmission component and a measurement structural component;
the transmission component is configured for driving the antenna array component to move by one circle around the target to be measured along the measurement structural component; and
the measurement structural component is configured for bearing the target to be measured, and accommodating the millimeter-wave component and the signal collecting and processing component.

Preferably, the millimeter-wave component includes the transmitting channel and the receiving channel, and the antenna array component includes a transmitting antenna array and a receiving antenna array;
the transmitting channel generates the millimeter-wave signal and sends the millimeter-wave signal to the transmitting antenna array, and the transmitting antenna array sends the millimeter-wave signal to the target to be measured; and
the receiving antenna array receives the echo signal of the target to be measured and sends the echo signal to the receiving channel, and the receiving channel receives the echo signal of the target to be measured and sends the echo signal to the signal collecting and processing component.

Preferably, the millimeter-wave component is of a receiving and transmitting integrated structure or a receiving and transmitting discrete structure;
the transmitting channel and the receiving channel of the millimeter-wave component are one of a single-transmitting single-receiving system, a single-transmitting multi-receiving system, a multi-transmitting single-receiving system and a multi-transmitting multi-receiving system; and
the millimeter-wave signal generated by the transmitting channel of the millimeter-wave component is a pulse signal or a continuous-wave signal.

Preferably, implementation forms of the transmitting antenna array and the receiving antenna array of the antenna array component include a microstrip antenna, a horn antenna, a slot antenna and a combination thereof; and
array arrangement forms of the transmitting antenna array and the receiving antenna array of the antenna array component include straight line distribution, broken line distribution, arc-shaped distribution and irregular distribution.

Preferably, fabrication materials of the measurement structural component include tetrachloroethylene and metal.

A millimeter-wave-based three-dimensional anthropometric measurement method includes the steps of:
S1. the transmission component driving the antenna array component to move to a designated initial position, and the target to be measured entering a measurement area on the measurement structural component and standing in a standard posture;
S2. the terminal device broadcasting measurement start by voice, and the transmitting channel of the millimeter-wave component generating the millimeter-wave signal and sending millimeter-wave signal to the antenna array component;
S3. the transmitting antenna array of the antenna array component sending the millimeter-wave signal to the target to be measured, and meanwhile the receiving antenna array of the antenna array component receiving the echo signal of the target to be measured and sending the echo signal to the millimeter-wave component, so as to acquire information about the target to be measured in a certain vertical dimension;
S4. the receiving channel of the millimeter-wave component receiving the echo signal of the target to be measured and sending the echo signal to the signal collecting and processing component, and the signal collecting and processing component collecting and processing the echo signal received by the millimeter-wave component, and sending the processed echo signal to the imaging algorithm and data processing component;
S5. the transmission component driving the antenna array component to move continuously around the target to be measured along the measurement structural component, and repeating S3 to S4, so as to acquire information about the target to be measured in a horizontal dimension, until the antenna array component returns to the designated initial position again;
S6. the terminal device broadcasting measurement end by voice, the millimeter-wave component and the transmission component stopping working, and meanwhile the imaging algorithm and data processing component stopping receiving data; and
S7. the imaging algorithm and data processing component performing the imaging algorithm operation on the echo signal processed by the signal collecting and processing component to obtain a measurement result, and the terminal device displaying the measurement result;
wherein the measurement result includes the three-dimensional image, the three-dimensional human body shape and the three-dimensional human body data of the target to be measured.

Preferably, the millimeter-wave component is of a receiving and transmitting integrated structure or a receiving and transmitting discrete structure;
the transmitting channel and the receiving channel of the millimeter-wave component are one of a single-transmitting single-receiving system, a single-transmitting multi-receiving system, a multi-transmitting single-receiving system and a multi-transmitting multi-receiving system; and
the millimeter-wave signal generated by the transmitting channel of the millimeter-wave component is a pulse signal or a continuous-wave signal.

Preferably, implementation forms of the transmitting antenna array and the receiving antenna array of the antenna array component include a microstrip antenna, a horn antenna, a slot antenna and a combination thereof; and
array arrangement forms of the transmitting antenna array and the receiving antenna array of the antenna array component include straight line distribution, broken line distribution, arc-shaped distribution and irregular distribution.

Preferably, fabrication materials of the measurement structural component include tetrachloroethylene and metal.

### (III) Beneficial Effects

Compared with the prior art, the millimeter-wave-based three-dimensional anthropometric measurement system and measurement method provided in the present disclosure have the following beneficial effects:
1) based on the non-contact measurement, measurement errors caused by external factors such as clothing are greatly reduced, especially in winter, the measurement errors caused by the clothing are greater, and compared with infrared and laser measurement methods, the present disclosure is higher in measurement accuracy, and has the advantage of a high measurement speed;
2) by adopting the millimeter-wave scanning, a whole body of the target to be measured may be scanned without taking off clothes, and sensitive parts of a human body can be fully recovered, so as to obtain an exquisite complete human body three-dimensional model, thereby better protecting individual privacy of the target to be measured; and
3) the present disclosure can be widely applied in scenes such as hospitals, research institutions, clothing design, pilot selection and soldier selection, and has great application value for the research on a change in the human body shape and a health status of the human body, and for some industries having more stringent requirements for the human body shape, and the like.

### BRIEF DESCRIPTION OF DRAWINGS

In order to more clearly illustrate the technical solutions in the examples of the present disclosure or the prior art, a brief introduction will be given to the accompanying drawings which need to be used in the description of the examples or the prior art below. It is apparent that the drawings in the following description are only some examples of the present disclosure, and for those ordinarily skilled in the art, other drawings may also be acquired according to these drawings without involving any inventive effort.

FIG. 1 is a frame diagram of a system of the present disclosure;

FIG. 2 is a schematic diagram of the system of the present disclosure;

FIG. 3 is a schematic flow diagram of the present disclosure; and

FIG. 4 is a schematic diagram of a measurement result of the present disclosure.

### DETAILED DESCRIPTION OF THE EMBODIMENTS

In order to make the objects, technical solutions and advantages of the examples of the present disclosure clearer, a clear and complete description of the technical solutions in the examples of the present disclosure will be given below in conjunction with the accompanying drawings in the examples of the present disclosure. It is apparent that the described examples are some examples, but not all examples of the present disclosure. Based on the examples in the present disclosure, all other examples obtained by those ordinarily skilled in the art without involving any inventive effort fall within the scope of protection of the present disclosure.

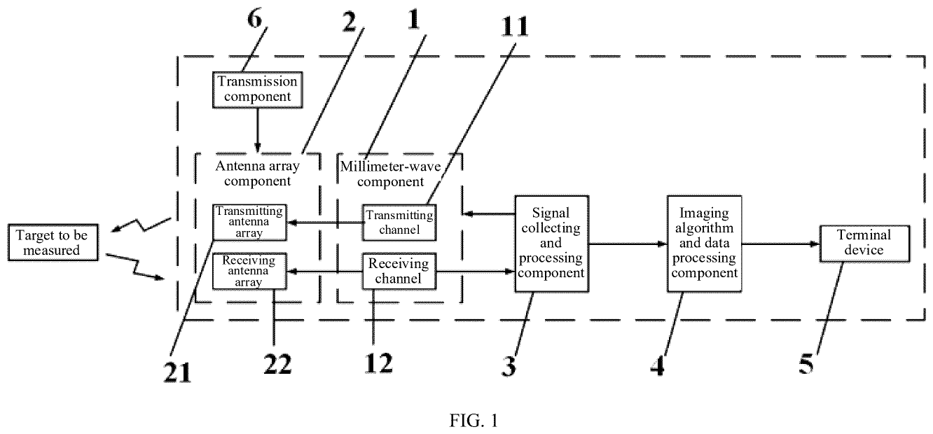

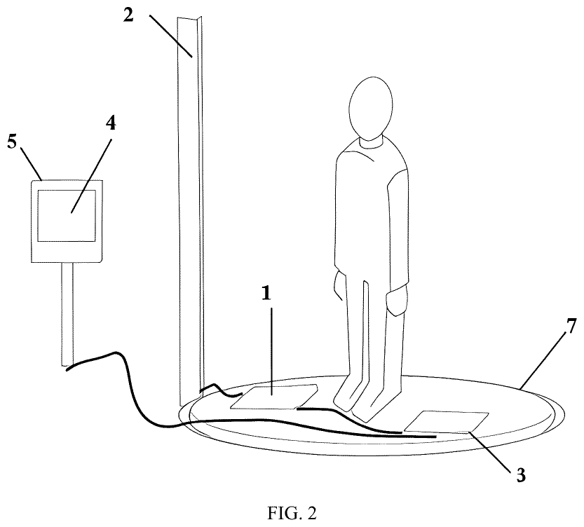

A millimeter-wave-based three-dimensional anthropometric measurement system, as shown in FIG. 1 and FIG. 2, includes: a millimeter-wave component 1, an antenna array component 2, a signal collecting and processing component 3, an imaging algorithm and data processing component 4 and a terminal device 5;
wherein the millimeter-wave component 1 is configured for generating a millimeter-wave signal and sending the millimeter-wave signal to the antenna array component 2, and receiving an echo signal of a target to be measured sent by the antenna array component 2;
the antenna array component 2 is configured for sending the millimeter-wave signal to the target to be measured, and receiving the echo signal of the target to be measured and sending the echo signal to the millimeter-wave component 1;
the signal collecting and processing component 3 is configured for controlling a transmitting channel 11 and a receiving channel 12 of the millimeter-wave component I to switch, and collecting and processing the echo signal received by the millimeter-wave component 1;
the imaging algorithm and data processing component 4 is configured for performing an imaging algorithm operation on the echo signal processed by the signal collecting and processing component 3, so as to achieve three-dimensional imaging of the target to be measured, and convert a three-dimensional image into a three-dimensional human body shape and three-dimensional human body data; and
the terminal device 5 includes control keys required by the system for displaying the three-dimensional image, the three-dimensional human body shape and the three-dimensional human body data of the target to be measured, and has a voice broadcasting function.

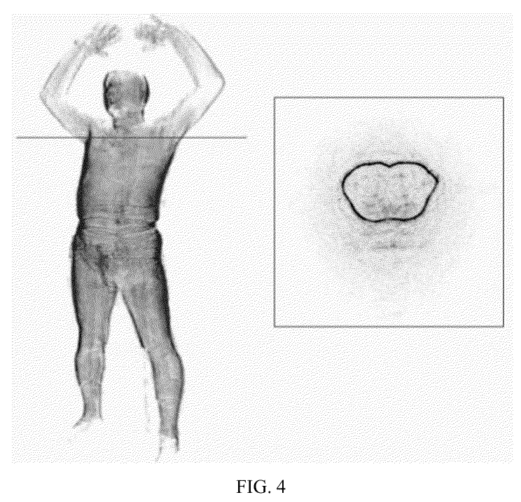

FIG. 4 is a schematic diagram of a measurement result of the present disclosure, wherein the three-dimensional image of the target to be measured is shown on a left side, a cross-sectional image of the human body at a position of a transverse line on the left side is shown on a right side, and the three-dimensional human body shape and the three-dimensional human body data may be obtained by different cross-sectional images of the human body in a vertical dimension.

In the technical solution of the present application, the millimeter-wave-based three-dimensional anthropometric measurement system further includes a transmission component 6 and a measurement structural component 7;
the transmission component 6 is configured for driving the antenna array component 2 to move by one circle around the target to be measured along the measurement structural component 7; and
the measurement structural component 7 is configured for bearing the target to be measured, and accommodating the millimeter-wave component 1 and the signal collecting and processing component 3.

Fabrication materials of the measurement structural component 7 include tetrachloroethylene and metal.

In the technical solution of the present application, the millimeter-wave component 1 includes the transmitting channel 11 and the receiving channel 12, and the antenna array component 2 includes a transmitting antenna array 21 and a receiving antenna array 22;
the transmitting channel 11 generates the millimeter-wave signal and sends the millimeter-wave signal to the transmitting antenna array 21, and the transmitting antenna array 21 sends the millimeter-wave signal to the target to be measured; and
the receiving antenna array 22 receives the echo signal of the target to be measured and sends the echo signal to the receiving channel 12, and the receiving channel 12 receives the echo signal of the target to be measured and sends the echo signal to the signal collecting and processing component 3.

The millimeter-wave component 1 is of a receiving and transmitting integrated structure or a receiving and transmitting discrete structure.

The transmitting channel 11 and the receiving channel 12 of the millimeter-wave component 1 are one of a single-transmitting single-receiving system, a single-transmitting multi-receiving system, a multi-transmitting single-receiving system and a multi-transmitting multi-receiving system.

The millimeter-wave signal generated by the transmitting channel 11 of the millimeter-wave component 1 is a pulse signal or a continuous-wave signal.

Implementation forms of the transmitting antenna array 21 and the receiving antenna array 22 of the antenna array component 2 include a microstrip antenna, a horn antenna, a slot antenna and a combination thereof; and
array arrangement forms of the transmitting antenna array 21 and the receiving antenna array 22 of the antenna array component 2 include straight line distribution, broken line distribution, arc-shaped distribution and irregular distribution.

Working frequencies of the millimeter-wave component 1 and the antenna array component 2 include a millimeter-wave frequency band and a terahertz frequency band.

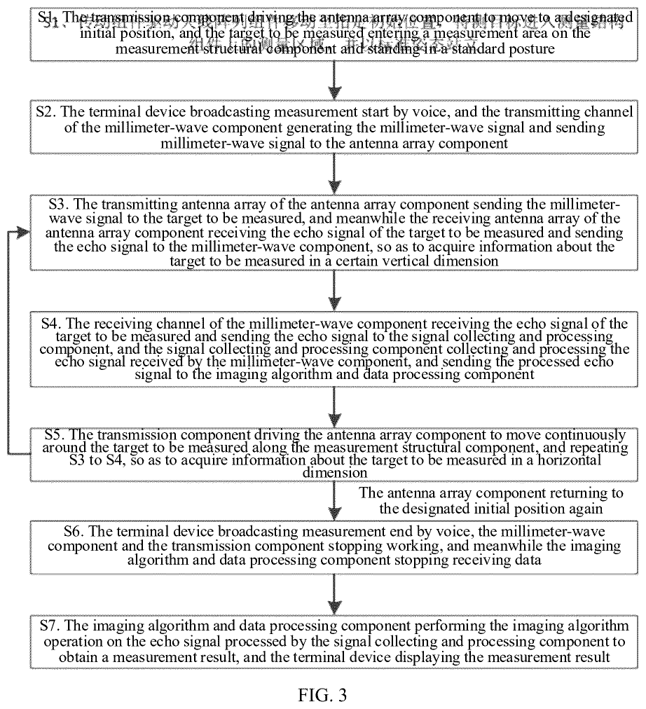

In the technical solution of the present application, a millimeter-wave-based three-dimensional anthropometric measurement method is further disclosed, as shown in FIG. 3, including the steps of:
S1. the transmission component 6 driving the antenna array component 2 to move to a designated initial position, and the target to be measured entering a measurement area on the measurement structural component 7 and standing in a standard posture;
S2. the terminal device 5 broadcasting measurement start by voice, and the transmitting channel 11 of the millimeter-wave component 1 generating the millimeter-wave signal and sending millimeter-wave signal to the antenna array component 2;
S3. the transmitting antenna array 21 of the antenna array component 2 sending the millimeter-wave signal to the target to be measured, and meanwhile the receiving antenna array 22 of the antenna array component 2 receiving the echo signal of the target to be measured and sending the echo signal to the millimeter-wave component 1, so as to acquire information about the target to be measured in a certain vertical dimension;
S4. the receiving channel 12 of the millimeter-wave component 1 receiving the echo signal of the target to be measured and sending the echo signal to the signal collecting and processing component 3, and the signal collecting and processing component 3 collecting and processing the echo signal received by the millimeter-wave component 1, and sending the processed echo signal to the imaging algorithm and data processing component 4;
S5. the transmission component 6 driving the antenna array component 2 to move continuously around the target to be measured along the measurement structural component 7, and repeating S3 to S4, so as to acquire information about the target to be measured in a horizontal dimension, until the antenna array component 2 returns to the designated initial position again;
S6. the terminal device 5 broadcasting measurement end by voice, the millimeter-wave component 1 and the transmission component 6 stopping working, and meanwhile the imaging algorithm and data processing component 4 stopping receiving data; and
S7. the imaging algorithm and data processing component 4 performing the imaging algorithm operation on the echo signal processed by the signal collecting and processing component 3 to obtain a measurement result, and the terminal device 5 displaying the measurement result;
wherein the measurement result includes the three-dimensional image, the three-dimensional human body shape and the three-dimensional human body data of the target to be measured.

FIG. 4 is a schematic diagram of a measurement result of the present disclosure, wherein the three-dimensional image of the target to be measured is shown on a left side, a cross-sectional image of the human body at a position of a transverse line on the left side is shown on a right side, and the three-dimensional human body shape and the three-dimensional human body data may be obtained by different cross-sectional images of the human body in a vertical dimension.

The millimeter-wave component 1 is of a receiving and transmitting integrated structure or a receiving and transmitting discrete structure.

The transmitting channel 11 and the receiving channel 12 of the millimeter-wave component 1 are one of a single-transmitting single-receiving system, a single-transmitting multi-receiving system, a multi-transmitting single-receiving system and a multi-transmitting multi-receiving system.

The millimeter-wave signal generated by the transmitting channel 11 of the millimeter-wave component 1 is a pulse signal or a continuous-wave signal.

Implementation forms of the transmitting antenna array 21 and the receiving antenna array 22 of the antenna array component 2 include a microstrip antenna, a horn antenna, a slot antenna and a combination thereof.

Array arrangement forms of the transmitting antenna array 21 and the receiving antenna array 22 of the antenna array component 2 include straight line distribution, broken line distribution, arc-shaped distribution and irregular distribution.

Fabrication materials of the measurement structural component 7 include tetrachloroethylene and metal.

The above examples are merely illustrative of the technical solutions of the present disclosure, and are not limiting of the technical solutions; although the present disclosure has been described in detail with reference to the foregoing examples, it should be understood by those ordinarily skilled in the art that the technical solutions disclosed in the above various examples may still be modified, or some of the technical features thereof may be replaced by equivalents; and such modifications or replacements do not enable the corresponding technical solutions to depart from the spirit and scope of the technical solutions in the various examples of the present disclosure in nature.

What is claimed is:

1. A millimeter-wave-based three-dimensional anthropometric measurement system, comprising: a millimeter-wave component (1), an antenna array component (2), a signal collecting and processing component (3), an imaging algorithm and data processing component (4) and a terminal device (5);
wherein the millimeter-wave component (1) is configured for generating a millimeter-wave signal and sending the millimeter-wave signal to the antenna array component (2), and receiving an echo signal of a target to be measured sent by the antenna array component (2);
the antenna array component (2) is configured for sending the millimeter-wave signal to the target to be measured, and receiving the echo signal of the target to be measured and sending the echo signal to the millimeter-wave component (1);
the signal collecting and processing component (3) is configured for controlling a transmitting channel (11) and a receiving channel (12) of the millimeter-wave component (1) to switch, and collecting and processing the echo signal received by the millimeter-wave component (1);
the imaging algorithm and data processing component (4) is configured for performing an imaging algorithm operation on the echo signal processed by the signal collecting and processing component (3), so as to achieve three-dimensional imaging of the target to be measured, and convert a three-dimensional image into a three-dimensional human body shape and three-dimensional human body data; and
the terminal device (5) comprises control keys required by the system for displaying the three-dimensional image, the three-dimensional human body shape and the three-dimensional human body data of the target to be measured, and has a voice broadcasting function.

2. The millimeter-wave-based three-dimensional anthropometric measurement system according to claim 1, wherein the system further comprises a transmission component (6) and a measurement structural component (7);
the transmission component (6) is configured for driving the antenna array component (2) to move by one circle around the target to be measured along the measurement structural component (7); and
the measurement structural component (7) is configured for bearing the target to be measured, and accommodating the millimeter-wave component (1) and the signal collecting and processing component (3).

3. The millimeter-wave-based three-dimensional anthropometric measurement system according to claim 2, wherein the millimeter-wave component (1) comprises the transmitting channel (11) and the receiving channel (12), and the antenna array component (2) comprises a transmitting antenna array (21) and a receiving antenna array (22);
the transmitting channel (11) generates the millimeter-wave signal and sends the millimeter-wave signal to the transmitting antenna array (21), and the transmitting antenna array (21) sends the millimeter-wave signal to the target to be measured; and
the receiving antenna array (22) receives the echo signal of the target to be measured and sends the echo signal to the receiving channel (12), and the receiving channel (12) receives the echo signal of the target to be measured and sends the echo signal to the signal collecting and processing component (3).

4. The millimeter-wave-based three-dimensional anthropometric measurement system according to claim 3, wherein the millimeter-wave component (1) is of a receiving and transmitting integrated structure or a receiving and transmitting discrete structure;
the transmitting channel (11) and the receiving channel (12) of the millimeter-wave component (1) are one of a single-transmitting single-receiving system, a single-transmitting multi-receiving system, a multi-transmitting single-receiving system and a multi-transmitting multi-receiving system; and
the millimeter-wave signal generated by the transmitting channel (11) of the millimeter-wave component (1) is a pulse signal or a continuous-wave signal.

5. The millimeter-wave-based three-dimensional anthropometric measurement system according to claim 3, wherein implementation forms of the transmitting antenna array (21) and the receiving antenna array (22) of the antenna array component (2) comprise a microstrip antenna, a horn antenna, a slot antenna and a combination thereof; and
array arrangement forms of the transmitting antenna array (21) and the receiving antenna array (22) of the antenna array component (2) comprise straight line distribution, broken line distribution, arc-shaped distribution and irregular distribution.

6. The millimeter-wave-based three-dimensional anthropometric measurement system according to claim 3, wherein fabrication materials of the measurement structural component (7) comprise tetrachloroethylene and metal.

7. A millimeter-wave-based three-dimensional anthropometric measurement method applied to the millimeter-wave-based three-dimensional anthropometric measurement system according to claim 3, comprising the steps of:
S1. the transmission component (6) driving the antenna array component (2) to move to a designated initial position, and the target to be measured entering a measurement area on the measurement structural component (7) and standing in a standard posture;
S2. the terminal device (5) broadcasting measurement start by voice, and the transmitting channel (11) of the millimeter-wave component (1) generating the millimeter-wave signal and sending millimeter-wave signal to the antenna array component (2);
S3. the transmitting antenna array (21) of the antenna array component (2) sending the millimeter-wave signal to the target to be measured, and meanwhile the receiving antenna array (22) of the antenna array component (2) receiving the echo signal of the target to be measured and sending the echo signal to the millimeter-wave component (1), so as to acquire information about the target to be measured in a certain vertical dimension;
S4. the receiving channel (12) of the millimeter-wave component (1) receiving the echo signal of the target to be measured and sending the echo signal to the signal collecting and processing component (3), and the signal collecting and processing component (3) collecting and processing the echo signal received by the millimeter-wave component (1), and sending the processed echo signal to the imaging algorithm and data processing component (4);
S5. the transmission component (6) driving the antenna array component (2) to move continuously around the target to be measured along the measurement structural component (7), and repeating S3 to S4, so as to acquire information about the target to be measured in a horizontal dimension, until the antenna array component (2) returns to the designated initial position again;
S6. the terminal device (5) broadcasting measurement end by voice, the millimeter-wave component (1) and the transmission component (6) stopping working, and meanwhile the imaging algorithm and data processing component (4) stopping receiving data; and
S7. the imaging algorithm and data processing component (4) performing the imaging algorithm operation on the echo signal processed by the signal collecting and processing component (3) to obtain a measurement result, and the terminal device (5) displaying the measurement result;
wherein the measurement result comprises the three-dimensional image, the three-dimensional human body shape and the three-dimensional human body data of the target to be measured.

8. The millimeter-wave-based three-dimensional anthropometric measurement method according to claim 7, wherein the millimeter-wave component (1) is of a receiving and transmitting integrated structure or a receiving and transmitting discrete structure;
the transmitting channel (11) and the receiving channel (12) of the millimeter-wave component (1) are one of a single-transmitting single-receiving system, a single-transmitting multi-receiving system, a multi-transmitting single-receiving system and a multi-transmitting multi-receiving system; and
the millimeter-wave signal generated by the transmitting channel (11) of the millimeter-wave component (1) is a pulse signal or a continuous-wave signal.

9. The millimeter-wave-based three-dimensional anthropometric measurement method according to claim 7, wherein implementation forms of the transmitting antenna array (21) and the receiving antenna array (22) of the antenna array component (2) comprise a microstrip antenna, a horn antenna, a slot antenna and a combination thereof; and
array arrangement forms of the transmitting antenna array (21) and the receiving antenna array (22) of the antenna array component (2) comprise straight line distribution, broken line distribution, arc-shaped distribution and irregular distribution.

10. The millimeter-wave-based three-dimensional anthropometric measurement method according to claim 7, wherein fabrication materials of the measurement structural component (7) comprise tetrachloroethylene and metal.
